(19) United States
(12) Patent Application Publication
(10) Pub. No.: US 2004/0113944 A1
(43) Pub. Date: Jun. 17, 2004

(54) Client screen on-demand creating system

(76) Inventor: Susumu Kawamura, Tsukuba-shi (JP)

Correspondence Address: Kernel Inc, 68 17 Aza Kotaro Shi basaki, Tsukuba shi, 3050004, JP

(21) Appl. No.: 10/343,544

(22) PCT Filed: Jul. 25, 2002
(86) PCT No.: PCT/JP02/07572

(30) Foreign Application Priority Data
Jul. 30, 2001 (JP) 2001-264969

(51) Int. Cl. G09G 5/00

(52) U.S. Cl. 345/744

(57) ABSTRACT

This is a construction process of a client-server system which can manage the display screen and operating conditions of each client in a concentrated manner, display the history that a client used if necessary, and have a dialog with a specific client using a character, a figure, etc. A server keeps the screen definition information of all screens and screen transition information that a client displays, and a server transmits screen definition information to a client according to a demand from the screen display program arranged at a client. By saving the screen identifier of the screen that a client shows at this moment, a server can grasp the screen that each client is using, manage a client, and have a dialog with a client.

### FIELD OF THE INVENTION

This invention relates to a process for grasping the state of a client in detail in a client-server system.

### BACKGROUND OF THE INVENTION

In a client-server system, since many clients have connected with one server, each client operates by giving a demand to a server and receiving an answer from a server. However, a server usually manages the operation state of a client individually. In order for an administrator and a support staff to look at the screen that a client uses remotely, a resident program that transmits the renewal information of a screen to a client is set and when change is shown in a screen, the screen is transmitted as picture information with which the pixel is located vertically and horizontally.

### SUMMARY OF THE INVENTION

Although the total of clients using a server, the user name of each client, etc. were acquirable in conventional client-server systems, it was difficult to grasp the detailed situation of each client such as the screen which each client is using or moves to the next, the inputted data, or the contents of work. Also, when a client user asks a question about the directions of a system or reports a problem of a system to the administrator of a system or the system support staff, it took much time to solve the problem because it was difficult to tell the situation only by telephone etc. Although there is a system that an administrator can also see the screen of each client in order to solve this, in this case, since the screen of a client is transmitted as picture information with which the pixel is located vertically and horizontally, the renewal speed of a screen will be slow and the amount of communications will also become huge.

In addition to this, when a system is suspended to maintain a system, or use of a part of function is restricted, there was no simple process of notifying all clients of it or forbidding that a new user connects with a system.

In order to solve the problem mentioned above, in this invention, the definition information about all the screens that a client displays, and the screen transition information of a screen which shows the relation between these screens are kept on a server. Information such as the screen identifier, which each client uses now, is kept on a server to understand which screen each client uses now. Also, a process for recording the history of screens that each client used is offered.

Furthermore, a process for transmitting a message to all or a specific client, and a process for a server also displaying the screen that a specific client shows and a client user and a support staff having a dialog using characters and figures are offered.

### BRIEF DESCRIPTION OF THE DRAWINGS

FIG. 1 is a system configuration of a client-server system where this invention is applied. 101 is a server and 114 is a client. Screen definition information 102 describes definition information of all screens displayed on a client 114 in the form that is shown in FIG. 2 for every screen. 201 has declared the name of a screen, and the size of a screen. Two or more screens exit can be defined on a screen, and a name is given to each screen exit in the form shown by 202. 203 is a definition of the display parts arranged on a screen, and describes the attribute of the classification of display parts, a display position, a size, and others. 204 is a definition of processing to specific screen parts, and in this example, when a button is pushed, the processing which escapes from a screen through an exit “O.K.” is described. The screen generated from the screen definition of FIG. 2 is as FIG. 3.

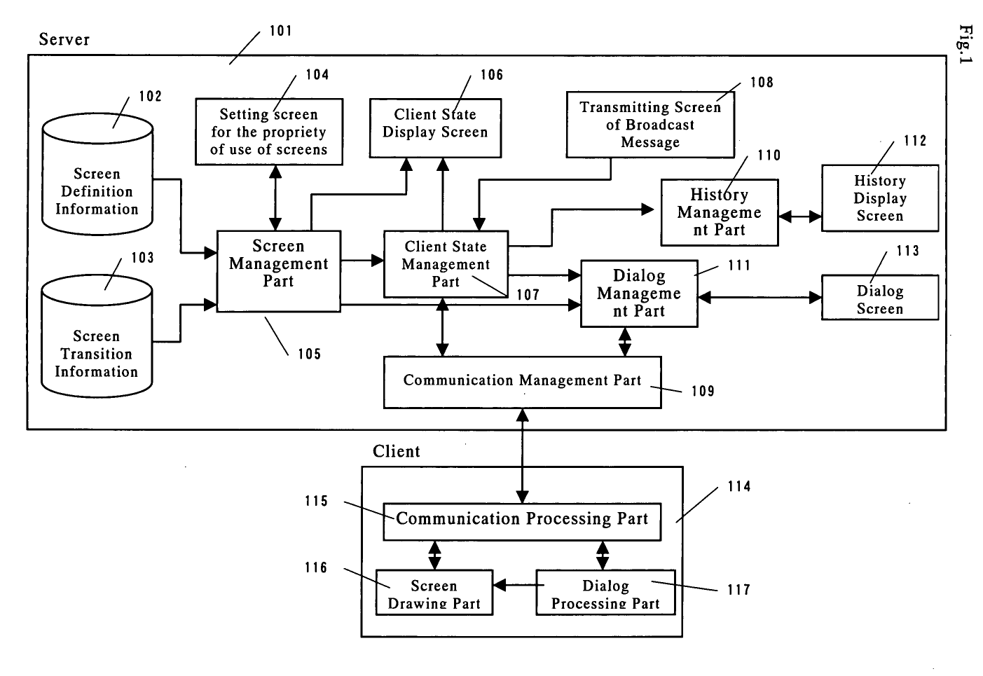

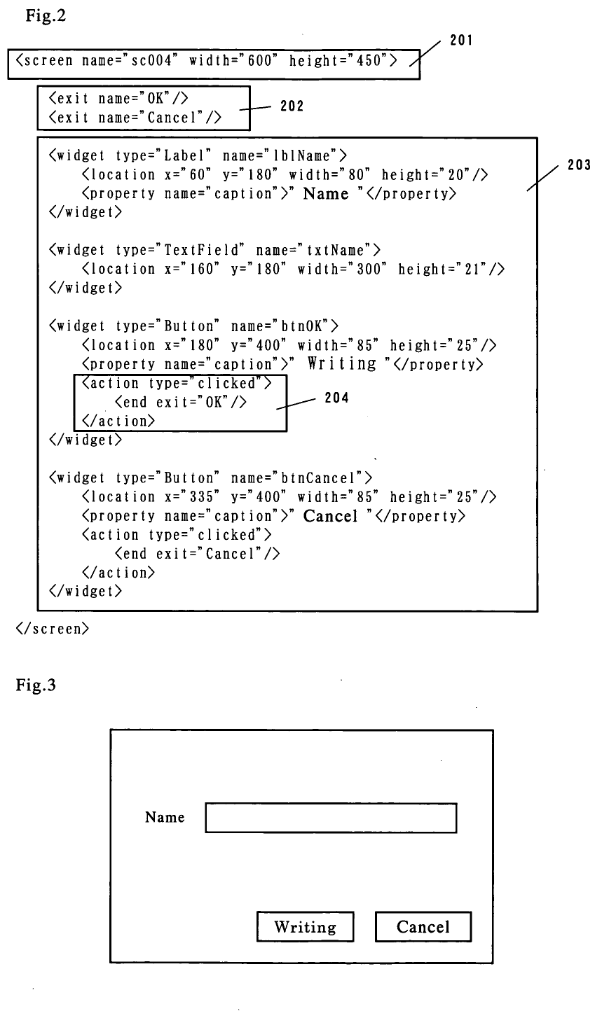

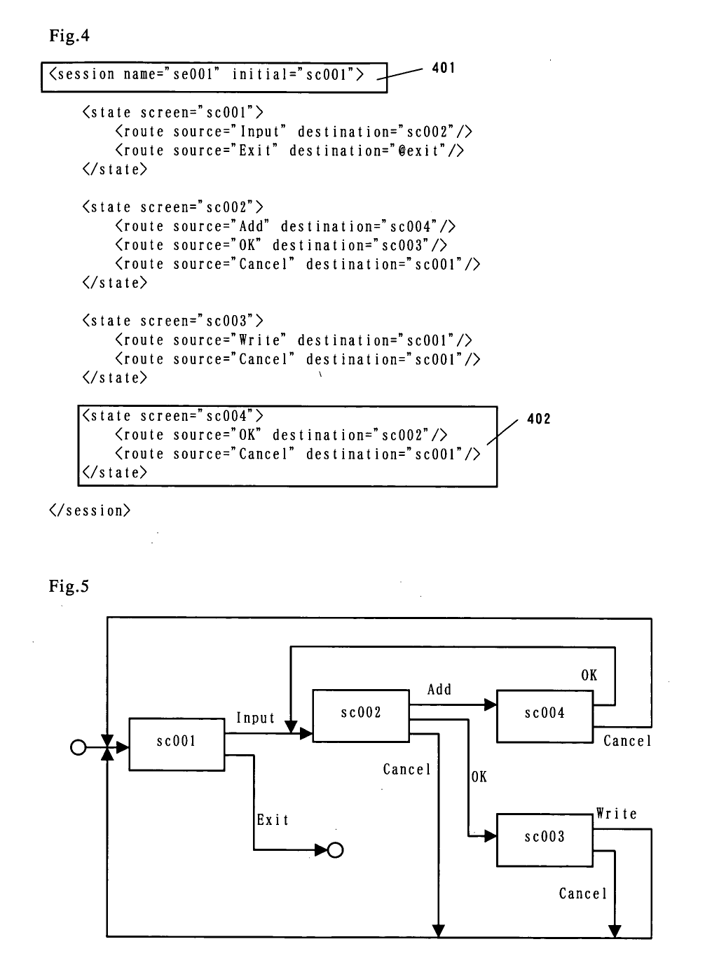

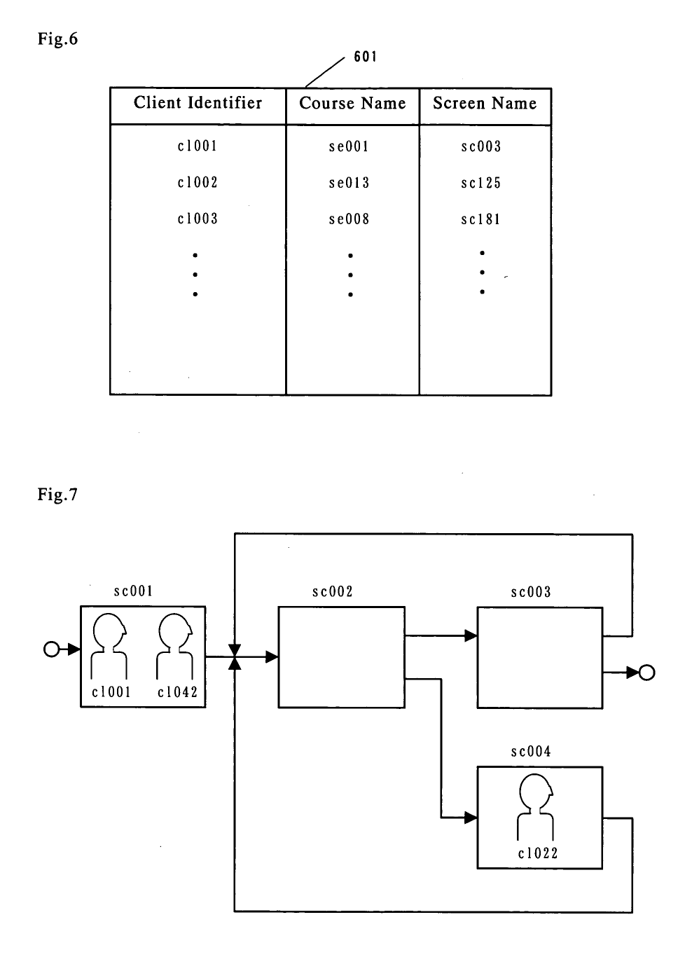

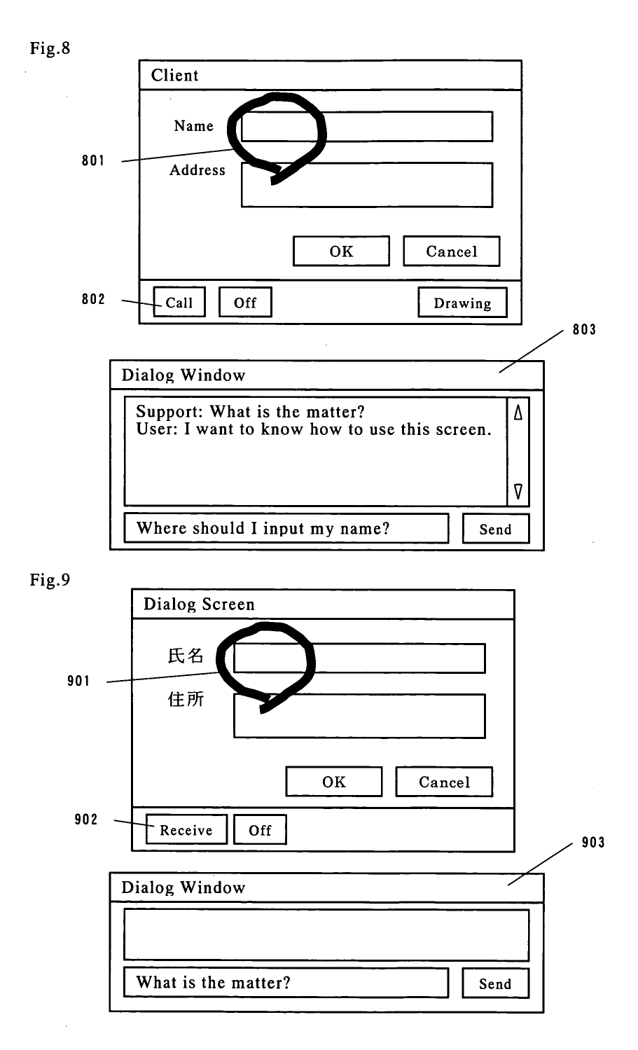

The relation between screens is described in screen transition information 103 in the form that is shown in FIG. 4. A screen course name and an initial screen are specified in 401. 402 shows one screen and transition is defined here. For example, when you escape from the exit “O.K.” of a screen “sc 004”, you move to a screen “sc 002”, and when you escape from the exit “Cancel”, you move to a screen “sc 001”. FIG. 5 illustrates visually transition of the screen defined in FIG. 4.

A screen management part 105 is a part that has the function that reads screen definition information 102 and screen transition information 103, and outputs suitable screen definition information according to a demand from the outside. Concretely speaking, 105 has the function to return the screen definition information of an initial screen on the relevant course when a course name is given, and the function to return the screen definition information of the next screen on a course when the name of a course, a screen, and an exit are given. Also, it has the function to permit or forbid using a specific screen on the setting screen 104 for the propriety of use of screens.

A client state management part 107 has the function to manage the state of all clients. Concretely speaking, information about the screen which each client uses now is kept in a client management table 601 shown in FIG. 6, and when there is a demand which shifts to the next screen from a client, the screen definition information of the screen to transit next is acquired and returned by asking the screen management part 105 based on the information kept in 601. When the screen of one of clients changes, the client state management part 107 notifies a history management part 110 of it. The client state display screen 106 acquires the state of all present clients from the client state management part 107 and displays which screen each client is using, together with the screen transition information acquired from the screen management part 105. An example of a screen display of the client state display screen is shown in FIG. 7.

A transmitting screen of broadcast message 108 acquires the list of clients that are operating now from the client state management part, and has the function to transmit a message for the client of all or a part of this list. In a client, a new window is generated and the message that received is displayed. When a system stops, all client users can be notified using this function.

A history management part 110 has the function to keep the history of screens that a client used. The screen use information given from the outside can be kept inside, and frequency of use of a screen, staying time, the number of times of course passage, etc. can be outputted according to a demand. A history display screen 112 has the function that acquires and displays various history information from the history management part 110.

A client 114 has the function that requires screen definition information of a server and draws a screen according to the received screen definition information. The procedure in which the client displays a screen is as follows. After starting operation, the client 114 transmits a screen course name to use to the server through a communication processing part 115.

The communication management part 109 of the server receives this and publishes a client identifier to this client, and passes to the client state management part 107 together with the demanded screen course name. The client state management part 107 adds the received client identifier and the screen course name to the client state management table 601, and demands the initial screen definition of the relevant screen course from the screen management part 105. After receiving the initial screen name and the screen definition information from the screen management part 105, 107 records the screen name in the client state management table 601 and returns the screen definition information to the client through the communication management part 109. The communication processing part 115 of the client receives the screen definition information, and passes this to a screen drawing part 116 and displays the screen. If the client user directs the transition to the following screen, the screen drawing part 116 will require the screen definition of the next screen from the server through the communication management part 115. After the client state management part 107 received the demand which transits to the following screen from the client through the communication management part 109, asks the screen management part 105 and acquires the screen name of the next screen and the screen definition, and records the screen name in the client state management table 601 and returns the screen definition to the client 114. The client 114 which received the screen definition draws this screen. The same processing is repeated when transition to the following screen is demanded.

A dialog management part 111 has the function to realize a dialog with a specific client. An example of a screen of a client 114 is shown in FIG. 8, and an example of a screen of the dialog screen 113 is shown in FIG. 9, respectively. The details of dialog processing are as follows. If a client user pushes “Call” button 802, the dialog processing part 117 of the client detects this and transmits the message that demands a dialog from a server through the communication processing part 115. The communication management part 109 of the server receives the demand of this dialog, and notifies the dialog management part 111. The dialog management part 111 which received the demand of the dialog notifies the dialog screen 113 of it. When the dialog screen 113 receives the demand of the dialog, 113 notifies the user of the dialog screen by blinking “Receive” button 902 on the screen. If the user of the dialog screen pushes “Receive” button 902, the dialog screen 113 will notify the dialog management part 111 of the message that received the demand of the dialog. After receiving the message, the dialog management part 111 will acquire the course name and screen name of the screen that the relevant client uses now from the client state management part 107. Based on the course name and screen name that were acquired, the dialog management part 111 acquires the relevant screen definition information from the screen management part 105, and transmits to the dialog screen 113. The dialog screen 113 receives the screen definition, draws the relevant screen, and displays a dialog window 903. The dialog management part 111 notifies that the demand of the dialog was received to the client through the communication management part 109. After receiving this notice, the communication processing part 115 of the client transmits the notice to the dialog processing part 117. By receiving this notice that demands the dialog, the dialog processing part 117 displays a dialog window 803. After that, the client user and the user of the dialog screen have a dialog with a dialog window using characters. Also, if a client user draws a figure shown in 801 with a mouse etc. on the screen, the figure information is transmitted to the dialog screen 113 through the dialog processing part 117, the communication processing part 115, the communication management part 109, and the dialog management part 111, and this figure is displayed as shown in 901 in the form which overwrites on the dialog screen. If a user of a dialog screen draws a figure with a mouse etc. on the dialog screen 113, the figure information is transmitted to the screen drawing part 116 through the dialog management part 111, the communication management part 109, the communication processing part 115, and the dialog processing part 117, and this figure is displayed in the form that overwrites on the screen. This dialog state is maintained until “Off” button is pushed by the client user or the user of the dialog screen.

### DESCRIPTION OF THE PREFERRED EMBODIMENTS

As mentioned above, this invention can keep screen definition information and screen transition information on a server, and can improve maintenance and management of a client-server system by managing the state of a client in a concentrated manner.

Also, the support in a client-server system can be improved by the message transmission to a client and the dialog between a support staff and a client user.

Furthermore, by recording the situation that a client uses screens on a server, a system operation test can be checked based on the number of times which passed the course, or the convenience of screens can be evaluated based on frequency of use or staying time.

What is claimed is:

1. A construction process of a client-server system characterized by keeping the screen definition information of all the screens that a client displays and the screen transition information that the display order of screens was defined on a server, memorizing the client identifier and the screen identifier of the screen displayed now for every client, and returning the screen definition information of the next screen to a client according to a demand of screen transition from a client;

2. A construction process of a client-server system characterized by recording information such as a screen identifier of the screen which changed, approach time to a screen, and escape time from a screen, and based on these information, acquiring information such as an order of screen use, staying time on a screen, and frequency of use of a screen, in claim 1 when a demand of screen transition is received from a client;

3. A construction process of a client-server system characterized by providing the function to permit or forbid using a specific screen by giving the information which shows the propriety of use of a specific screen to the screen transition information which a server keeps in claim 1;

4. A construction process of a client-server system characterized by providing the function which transmits data such as character strings from a server to a specific or all clients based on the client identifier which a server has memorized and is displayed by the client in claim 1;

5. A construction process of a client-server system characterized by providing the function which a server can display the screen that a specific client shows based on the screen identifier which screen definition information and a server have memorized, displays the figure which a client and a server drew on each screen with an input device such as a mouse on another side, and displays information such as character strings which a client and a server inputted respectively on another side in claim 1.
